(19) United States
(12) Patent Application Publication
(10) Pub. No.: US 2017/0069215 A1
(43) Pub. Date: Mar. 9, 2017

(54) ASSESSMENT OF CORE EDUCATIONAL PROFICIENCIES

(71) Applicants: Robert A. Borofsky, Kailua, HI (US); Christopher Mark Hanington, Kailua, HI (US)

(72) Inventors: Robert A. Borofsky, Kailua, HI (US); Christopher Mark Hanington, Kailua, HI (US)

(21) Appl. No.: 15/259,022

(22) Filed: Sep. 7, 2016

Related U.S. Application Data
(60) Provisional application No. 62/215,257, filed on Sep. 8, 2015.

(51) Int. Cl. G09B 7/04

(52) U.S. Cl. CPC G09B 7/04

(57) ABSTRACT

The present system and method for assessment of core educational proficiencies (ACEP) is directed to a system and method for administering, training, developing, grading and reporting the scores of an assessment test for critical thinking, problem solving and effective writing. The ACEP web-based computer implemented system and method for assessment of core educational proficiencies more particularly comprises a computer network server having a data storage and memory configured to administer an assessment, said assessment comprising a first test and a second test wherein said first test and said second test each include three essay questions to be answered by writing essays totaling for all three essay questions at least 900 words, grading said essay answers for effective, organized writing, grammar and spelling and grading said essays for critical thinking, problem solving and task management skills to generate test results and recommendations, as well as generating and disseminating reports of said test results and recommendations.

### FIELD OF THE INVENTION

The present invention is directed to a system and method for assessment of core educational proficiencies, and more particularly to a system and method for administering, training, developing and grading and reporting the scores of an assessment test for critical thinking, problem solving and effective writing.

### BACKGROUND OF THE INVENTION

Something is clearly amiss in higher education. For years now college tuition has been outpacing inflation—in some cases doubling and even tripling in recent years. Student loans, to cover that increased cost, now total well over a trillion dollars. Yet it is unclear what skills students gain from their years at college, especially whether they gain the key career skills needed to work their way out of their college debt and into successful careers.

1. Academic studies questioning what students learn: If we start with academic studies of what students learn in college, one of the most prominent is Arum and Roksa's Academically Adrift (University of Chicago Press, 2011). In respect to critical thinking, problem solving, and effective writing, they found among a number of universities perhaps 45% of college students “do not demonstrate any significant improvement in learning” during their first two years of college. In four years of college, 36% of the students “do not demonstrate any significant improvement in learning” in these areas (see Scott Jaschik, ‘Academically Adrift’ Inside Higher Ed, Jan. 18, 2011). Students that do show improvement tend to demonstrate only modest improvement. The Wabash National Study (Ernest Pascarella and Patrick Terenzini “Some New Evidence on What Matters in Student Learning” Preliminary Address to CIC Institute, 2011 Wabash National Study of Liberal Arts Education) using a sample of small liberal arts colleges and as different, but another well respected test, came to roughly the same conclusion.

2. Additional data questioning what students learn: These are not isolated results. The National Assessment of Adult Literacy (NAAL) (Charles Miller & Geri Malandra “Accountability/Assessment” Second in a series of Issue Papers released to inform the work of the Secretary of Education's Commission on the Future of Higher Education, n.d.) indicates that among college graduates less than one-third can demonstrate the ability to read complex tests and make complicated inferences. The American Institutes of Research (Charles Miller & Geri Malandra Ibid.) in its National Survey of College Students found that among college graduates, 20% lacked basic quantitative skills such as calculating the total of an office supply order. Fifty percent could not demonstrate such basic skills such as summarizing arguments in a newspaper editorial. The Educational Testing Service's Academic Profile reports that only 11% of college seniors are proficient in writing and only 6% in critical thinking. The report indicated 77% were viewed as not proficient (Liberal Education Outcomes, A Preliminary Report on Student Achievement in College, Association of American Colleges and Universities, 2005: Chapter 5).

3. Employers questioning of what students learn: Employers' perceptions of college graduate competencies overlap with these studies. An article in The Chronicle of Higher Education, entitled “A College Degree Sorts Job Applicants, but Employers Wish It Meant More,” (Karin Fischer, A26 Mar. 8, 2013) reports “half of [the employers surveyed] . . . by The Chronicle and American Public Media's Marketplace said they had trouble finding recent graduates to fill positions at their company or organization. Nearly a third gave colleges just fair to poor marks for producing successful employees. And they dinged bachelor's-degree holders for lacking, basic workplace proficiencies, like adaptability, communication skills, and the ability to solve complex problems.” In a study commissioned by Chegg (involving over 2,000 interviews), employers reported “fewer than two in five hiring managers (39%) say the recent college graduates they have interviewed in the past two years were completely or very prepared for a job in their field of study” (Bridge That Gap; Analyzing, the Student Skill Index, Fall 2013; 3).

4. Gap between employers and colleges/students regarding students career readiness: Interestingly, most college administrators do not perceive the failings of their college graduates. An article in Inside Higher Ed reports 96% of provosts view they are doing a good job at preparing students for success in the workplace. (Mile Grasgreen “Provosts, business leaders disagree on graduates' career readiness” Feb. 26, 2014). This contrasts with a recent Gallup survey indicating “just 14 percent of Americans—and only 11 percent of business leaders—strongly agreed that graduates have the necessary skills and competencies to succeed in the workplace” (Ibid). A related gap exists between student and employers. Another Inside Higher Ed reports “in a number of key areas (oral communication, written communication, ethical thinking, being creative), students are more than twice as likely as employers to think that” they are well-prepared for their future career. In respect to critical/analytical thinking, for example, 66% of the students viewed themselves as prepared versus 26% of the employers, regarding written communication it was 65% versus 27%, and for analyzing/solving complex problems, it was 59% versus 24%. Scott Jaschik “Study finds big gaps between student and employer perceptions” Inside Higher Ed January 20. These data fit with an article in the Economist “Not what it used to be,” Dec. 1, 2012. During the current wave of unemployment, there are three million unfilled positions needing skilled workers.

5. Federal efforts to address limited learning problem: The federal and state governments are aware of the problem. A Test of Leadership, Charting the Future US. Higher Education, the 2006 report of the commission appointed by former Secretary of Education Margaret Spellings, p. 4), states:
We believe that improved accountability is vital to ensuring the success of all the other reforms we propose. Colleges and universities must become more transparent about cost, price, and student success outcomes, and must willingly share this information with students and families. Student achievement, which is inextricably connected to institutional success, must be measured by institutions on a “value-added” basis that takes into account students' academic baseline when assessing their results.
   Secretary Spelling sought to impose these changes on colleges and universities through increasing the power and requirements of regional accrediting boards. Schools that fail their accreditations, that fail to live up to these boards' requirements, have their federal funding withdrawn often forcing such schools to close.

6. State efforts to address limited learning problem: State governments have put pressure on their public universities. (A majority of the student population attend public universities.) We can track this pressure through some of The Chronicle of Higher Education's articles. A Nov. 28, 2010 headline (by Sara Hebel) notes “States Seek Ways to Take Measure of College Degrees:” an Oct. 28, 2013 headline reports “States Demand That Colleges Show How Well Their Students Learn” by Dan Berrett. A nine state consortium, focusing on critical thinking, quantitative reasoning, and writing, this latter article notes, would like to “have a clear, understandable way to describe learning [in college].”

7. College responses to federal and state pressures: How did colleges respond to these challenges? In a 2011 interview former U.S. Secretary of Education Spellings was asked: “The commission found that higher education in the United States needs to improve in ‘dramatic ways,’ changing from a system primarily based on reputation to one based on performance. Has this happened?” She answered “Not enough, . . . clearly the pace has been too slow.” Secretary Spellings continues “Are we doing a better job of measuring student-learning outcomes? . . . A baby-step better.” (Q&A: Former Secretary Of Education Margaret Spellings Discusses The Impact Of Her Commission, Chronicle of Higher Education, Sep. 17, 2011).

A Chronicle article (by Paul Basken) from Feb. 1, 2008 reads “Colleges Emerge the Clear Winner in Battle Over Accreditation.” It Continues: “If the accreditation battles of the past year had been a boxing, match, the referees probably would declare American colleges the winner by a technical knockout. The latest example is the victory the colleges have secured in a fight with accreditors themselves over proposed legislative language. The outcome appears to have removed the institutions last major obstacle to asserting their right to define academic success, . . . after weeks of intensive negotiations, the colleges and the accreditors have reached a settlement. The result? They agreed to . . . [give] colleges the authority to set the terms of their own academic evaluations. The compromise language does give the accreditors the right to suggest some measures, like faculty qualifications or student test results, by which the colleges will be judged. But, according to participants in the talks, the new language also makes clear that in the case of disagreements, the colleges would retain final authority.”

This helps explain why, despite earnest attempts made, graduates continue to display limited learning from their years at college. Again, Chronicle headlines are instructive. A Jan. 24, 2014 headline reads “Colleges Measure Learning in More Ways, but Seldom Share Results,” The article, based on a report of over 1,200 college administrators, notes “assessment results seldom leave the campus, the researchers found. Less than one-third of colleges post such results on their websites . . . the use of evidence was not as pervasive as it needed to be.” Another Apr. 21, 2014 headline reads “Colleges Back Away From Using Tests to Assess Student Learning.” It states, “feeling pressure from federal policy makers and the public to demonstrate rigor in their courses, colleges turned to the tests as seemingly objective measures of quality and what students are learning.” It continues “But then momentum slowed. A leading advocacy group for the disclosure of student-learning outcomes quietly closed. Another project has seen flagging interest. Researchers have cast doubt on the reliability of some standardized measures of learning . . . professors have become more interested in tools that allow them to standardize their assessment of their students performance on homegrown assignments instead of using outside tests.”

Writing illustrates the problem. Despite the extensive effort high schools and colleges put into improving student writing, many college graduates possess weak writing skills, Inc. recently reported that “a study from College Board, a panel established by the National Commission on Writing, indicates that blue chip businesses are spending as much as $3.1 billion on remedial writing training-annually.” Inc. continues, “a report from the Partnership for 21^{st}-Century Skills noted that according to employers, 26.2 percent of college students had deficient writing skills.” Inc. adds, “College students admit their poor writing proficiency too. The 2011 book Academically Adrift which followed more than 2,300 students through college, found only 50 percent of seniors felt their writing skills had improved over the course of their four-year education.”

8. Summarizing—More is involved in addressing the problem than finding an exam to test students: Addressing the problem of what skills students learn in college involves more than simply finding the right test to effectively assess learning. It also involves considerable politics focusing particularly on drawing colleges and their faculties into committing themselves to such assessments. Some tests—such as ETS's College Boards or ACT's College Readiness Assessments—have built up enough authority, over time, to skip such involvement. But it should be noted that these tests focus on what students know before entering college, not during college. Poor results on them do not reflect negatively on the colleges. For assessments of what students learn in college to be successfully implemented today, colleges need feel it is to their advantage to conduct them. Faculty need to feel that, being drawn into greater accountability for what they teach, can be a form of empowerment. It can publicly demonstrate their skills as teachers.

### Seven Major Tests

Presently, there are seven prominent tests that assess critical thinking, problem solving and effective writing among college-age students today. Before turning to their limitations in addressing what students learn in college, a brief description of each is in order.

1. CAT (Critical Thinking Assessment) was developed at Tennessee Tech University with NSF assistance. It involves fifteen short answer questions, each usually answered in three or four sentences. A set of questions asks, for example, what is involved in preparing for a family hiking/camping, trip. It is graded by faculty using a set of clear criteria that leads to a score between zero and five for each question. Faculty grading is central to the test because CAT hopes that in seeing the limitations of their students' skills, faculty will be encouraged to address them.

2. CLA (Collegiate Learning Assessment) was developed by the Council for Aid to Education. Students are assessed as a cohort (such as a sample of freshman or seniors) rather than as individuals. The CLA is given in three formats, a performance task—which involves short 40 to 80 word answers to five to seven questions, a “make an argument” analytic essay of perhaps 100-150 words and a “critique an argument” analytical essay of roughly the same length. Students have 45 minutes for each analytical essay or 90 minutes for the performance task. These three formats collectively assess a cohort's “higher ordering thinking skills” involving writing mechanics, writing effectiveness, problem solving, and analytical reasoning and evaluation. They are assessed on rubrics of six points each.

3. NSSE (National Survey of Student Engagement) was an initiative of the Pew Charitable Trusts that became associated with the Center for Postsecondary Research at Indiana University. It assesses key skills indirectly by focusing on the time and effort students spend on their studies as well the demands of various courses. Thus, for example, students are asked how many assigned books or how many papers (of varying length) they have done over the past school year. They are also asked, “during the current school year, how much has your course work emphasized” memorizing facts, analyzing elements of an idea, synthesizing ideas into more complex interpretations, making judgments about the value of certain information and/or applying theories to practical problems? Students often choose from one of four options: very much, quite a bit, some, and very little. The implication is that if students are assigned certain tasks, if certain demands are placed on students, they will develop key higher order thinking skills. NSSE also asserts that asking such questions also provides a framework for improving a school's curriculum. The tests take relatively little time and/or effort. They involve checking the box that best fits a student's experiences for each of roughly 30 questions.

4. CAAP (Collegiate Assessment of Academic Proficiency) involves a set of standardized questions that measures a student's level of achievement over a range of skills including writing skills, written essays, and critical thinking. The writing skills test involves a 72 item multiple choice 40-minute test that measures a student's grammatical and “rhetorical skills” (i.e. selecting which style is appropriate for which audience). The written essay involves two 20-minute writing assignments which are evaluated on how students formulate, organize and support a particular position in clear, effective language. Critical thinking involves a 32-item, 40-minute test that measures, through multiple choice questions, a student's skill at analyzing, evaluating, and developing certain arguments. The results are presented as the percentage of students at the student's school and/or nationally who scored at the student's level, below or above it. Essays have a general overall grade on a six-point scale ranging from inadequate through competent to exceptional.

5. ETS's Proficiency Profile, like the CAAP, assesses a number of skills. In respect to the skills discussed here, there are 27 multiple choice questions on critical thinking and 27 multiple choice questions on writing. These last a total of one hour. The critical thinking assesses a student's ability to (a) distinguish among different forms of argumentation, (b) recognize the best hypothesis for explaining the relationship among certain variables, and (c) draw valid conclusions from particular information. The writing portion assesses the student's ability to use grammatically appropriate language, reword figurative language, and organize various specifics into a larger, coherent passage. The Proficiency Profile also has an optional 30-minute essay that asks the student to write a well-organized argument that supports a particular position on a specific issue. The essay is graded on a six-point scale that highlights its main qualities.

6. CCTST (California Critical Thinking Skills Test) is a multiple choice test of roughly 40 questions that last up to 60 minutes. It is run by Insight Assessment and grew out of the Delphi Report to the American Philosophical Association on critical thinking. It focuses on seven elements of critical thinking: analysis (examine assumptions), interpretation (determine meaning of a passage), inference (draw reasonable conclusions), evaluation (assess a claim's credibility), explanation (provide reasons for a conclusion), as well as inductive and deductive reasoning. While claiming to use everyday scenarios, its questions tend to be somewhat abstract. A sample question, for example, might be considering a particular claim, which of the following pieces of information would not weaken that claim or which of the following headlines must logically be true. The test is taken online.

7. PISA (Programme for International Student Assessment), a product of the OECD (Organization for Economic Cooperation and Development), is the most international of the assessments with, in 2015, 75 counties participating in it. It openly ranks countries on how well they do: It recently reported, for example, that students in Korea and Singapore scored better in problem solving on PISA than students in 73 other countries. The test involves four core assessments: science, reading, mathematics, and collaborative problem solving. The problem solving portion involves 43 multiple choice questions. Its questions are divided into two categories: interactive problems (involving uncovering useful information in the environment/context that will allow as person to solve it) and static problems (where a student is presented with certain information from which an answer can be logically deduced). An interactive problem, for example, might involve being presented with an MP3 player and having to figure out, from the information on the screen, how it works. A static problem might involve watching a robot cleaner being stopped by various obstacles and figuring out the rules that govern (or predict) how the robot reacts to such obstacles.

### What These Tests Miss

1. VALIDITY: Do the tests accurately assess critical thinking, problem solving and effective writing?

A. What constitutes critical thinking—focusing on post-graduation every day and career problems: While perhaps 90% of university faculty believe critical thinking is the most important skill students should learn in college, there is little consensus on how that is defined. As a result, different tests focus on different variables. Steedle, Kuglemasss and Nemeth (in What Do They Measure, www.changemag.org) write: “we have concluded that [while there is] . . . some evidence concerning the validity of the CAAP, the CLA, and the ETS Proficiency Profile as learning outcomes measures, it supplies insufficient evidence to support the contention that their scores are comparable. All three assessments provide reliable indicators of student achievement and they seem to be sensitive to learning that occurs in college. But it is not clear that tests with the same name (e.g. critical thinking) actually measure the same constructs” (2010:33-34).

As a result, it makes sense to focus on the contexts in which students will need certain critical thinking and problem solving skills in their everyday post-graduation lives and especially in their careers. The test questions should not deal with abstract, academic issues. Rather, they should locus on the type of problems they will likely face after graduation—not ones that have clean, precise answers but ones that have subtle, diverse, complicated and ambiguous answers. This is important because cognitive research suggests that skills acquired in one context do not necessarily extend to other, unrelated contexts. Just because students can address abstract, logical puzzles in one of these tests, for example, does not mean they can resolve complex problems in their everyday lives and jobs.

B. Critical thinking, problem solving and writing should be assessed together: Just as critical thinking cannot readily be separated from problem-solving—the context in which it is frequently utilized—it cannot easily be separated from writing—how it is displayed in concrete form. Students cannot be restricted to choosing among five multiple-choice alternatives for complex problems that could involve ambiguous answers that might be correctly responded to in diverse ways.

In terms of 1A's and 1B's standard (a) focusing on post-graduate problems and (b) the entwining of critical thinking, problem solving and writing skills—the seven tests collectively do poorly. Generally, the tests focus on abstract questions students are more likely to encounter in college than in a professional work environment or in their everyday post-graduate lives. This is especially clear for CAAP. Personality Profile, CCTST and PISA which are all multiple choice tests. It seems unlikely that many important professional work problems can be properly answered through multiple-choice responses. Only PISA, with its interactive element, might be viewed as relatively realistic. But again, it is a multiple choice test with precise answers. NSSE could be relevant to post-graduate experiences. But NSSE does not explain in what ways and to what degree extensive reading in college leads to a wider post-graduate intellectual perspective about the world that, in turn, helps solve important work problems; it remains unclear. It constitutes a presumption no more.

ETS's Personality Profile, CAT and CLA, involve varying degrees of writing. The Personality Profile's optional essay does not fit that well with its own or other critical thinking questions. It involves the standard type of paper you would find in many college courses. CAT's short answers allow for some ambiguity and creativity. But the questions, especially for students who are unfamiliar with outdoor hiking and camping, may seem somewhat alien. In respect to the CLA, there is more room for ambiguity. One question considers, for example, whether a correlation between more police and greater crime allows a student to infer that the former causes the latter. But a number of questions do not seem particularly relevant to many students' experiences nor the problems they encounter after graduation. It is hard to see why students would be really motivated to answer them in any depth.

C. Do the questions motivate students to provide thoughtful, comprehensive answers? The above point raises an important question regarding validity: Are students motivated enough to take a lengthy, substantial test seriously enough so their answers represent a reasonably valid assessment of their abilities. Jaschik reports in an article entitled “Tests With and Without Motivation” (Inside Higher Ed Jan. 2, 2013) that a “study by three researchers at the Educational Testing Service . . . raises questions about whether the tests can be reliable when students have different motivations (or no motivation) to do well on them. The study found that student motivation is a clear predictor of student performance on the tests, and can skew a college's . . . score.” When questions are relatively divorced from students lives, students may not be that motivated to answer them.

This relates to a common concern noted in the literature. Students familiar with say biology may be asked questions relating to economics. Unless students with different majors share a common interest involving the questions asked, they may respond to them differently. They also may not take seriously questions on topics they are unfamiliar or unconcerned with.

By this standard, five of the seven tests do poorly: CLA, NSSE, CAAP, Proficiency Profile, and CCTST. For students experienced with rural environments, some of the CAT's questions should resonate with their backgrounds and hold their interest. PISA's interactive problems may also hold students' attention. They involve a student exploring various possibilities presented on the screen rather than passively reading a test question and then clicking on a multiple choice answer. But none of the tests address problems that are of deep and immediate concern to most students taking them. The questions may be intellectually interesting. But they rarely grab students to the degree that they would likely repeatedly provide lengthy thoughtful, comprehensive answers and spend three to four hours completing them. One might wonder whether those creating the tests did not feel students could be kept actively engaged with the intellectual topics being addressed for that length of time.

D. Having a single overall score versus multiple distinct scores: It may be administratively convenient to summarize a complex subject such as critical thinking with a single score. But common sense suggests that much might be left out. Most tests provide a single score for problem solving and critical thinking. Two, CAT and CLA, are more subtle.

CLA, for example, separates out problem solving from analytical reasoning and evaluation. But without explaining why, it combines under problem solving: “(a) provides a decision and a solid rationale based on credible evidence from a variety of sources. Weighs other options, but presents the decision as best given the available evidence . . . . (b) proposes a course of action that follows logically from the conclusion. Considers implications. [and ] (c) recognizes the need for additional research. Recommends specific research that would address most unanswered questions.” Again without explanation, it combines for analytical reasoning and evaluation “(a) identities most facts or ideas that support or refute all major arguments (or salient features of all objects to be classified) presented in the [documents]. Provides analysis that goes beyond the obvious. (b) Demonstrates accurate understanding of a large body of information from the [documents]. (c) Makes several accurate claims about the quality of information.” Why should these traits be combined and others excluded is not made clear. Equally important, what are the exact standards used for emphasizing each of these distinct features. How is a test scored if it has one element of say problem solving done well and two others done poorly or vice-versa?

CAT is the best test in this regard. It has four skill categories: evaluating information, creative thinking, learning and problem solving, and communication. Like the CLA it then has various subcategories under each. Unlike the other tests, it provides a concrete basis for seeing how a certain answer leads to a certain score for each of the four skill categories (but not subcategories). This allows students an understandable path for seeing what they did wrong and how to improve their skills. But it would be better still if the CAT separated out the 12 subcategory skills it lists and related them directly to specific questions.

E. What sorts of skills should be included in the test? As noted, critical thinking, problem solving and effective writing should be assessed together. Reading through various articles regarding employers' perceptions of what skills college graduates lack, we find repeated reference to “soft skills.” Quoting White (The Real Reason New College Grads Can't Get Jobs, Time. Com, Nov. 10, 2013) “the annual global Talent Shortage Survey from Manpower Group finds that nearly 1 in 5 employers worldwide can't fill positions because they can't find people with soft skills. Specifically, companies say candidates are lacking in motivation, interpersonal skills, appearance, punctuality and flexibility.” It would be hard to assess all five of these skills in a standard test. But it is quite possible to focus on a skill such as task management: Does the student answer the question that is asked (not respond to an unrelated question)? Does the student follow directions correctly? Does the student complete the test in the time specified? By this standard, all of the tests do poorly. None of them provide results that allow others to assess a “soft skill” such as task management.

2. RELIABILITY: Do the tests repeatedly yield the same results?

A. Having more than one test to insure reliability: Dwyer, Milley and Payne (in A Culture of Evidence, www.ets.org, 2006:12) emphasize a well-known but commonly downplayed point. “High-stakes decisions should not be based on a single test.” Common sense would suggest that there should be at least two overlapping assessments that insure there is some consistency through time to a student's responses. By this standard—having two or more tests that measure the same skills in the same manner—all seven assessments do poorly. None of the test are repeated within a limited period of time, say a week, to ensure the results are reliable.

B. Reducing variations in grading, especially in essays: It seems reasonable to assume that variation in grading among teachers is much less of a problem with multiple choice questions than with essays. Teachers (or grading machines) will generally assess the same multiple choice question in the same way no matter how many times it is graded or how many people grade it. The correct answer to question X will always be Y for example. That means NSSE, CAAP, Proficiency Profile, CCTST and PISA do not face a noticeable problem in this respect.

But there is a clear problem with essay exams. As students anecdotally emphasize, different teachers often grade the same essay differently. That is why the grading rubrics are important. CAT does not use a rubric as much as a flow chart (e.g. if the students answers A, then go to B and add one point; if he or she answers C then go to 13 and add two points). Moreover, two teachers grade it separately. If they disagree on a score, a third teacher grades the short answer as well with the majority decision being the final score.

The CLA, as noted above, uses a 6-point rubric. Different graders may well grade the same essay in a different way, especially given the subtle differences between each number. Take, for example, the CIA's difference between a 4, 5, and 6 for problem solving. A 6 involves proposing “a course of action that follows logically from the conclusion. Considers implications;” a 5 involves proposing “a course of action that follows logically from the conclusion. May consider implications;” a 4 involves proposing, “a course of action that follows logically from the conclusion. May briefly consider implications,” There are differences between a 4, 5, and 6. But they are subtle and open to divergent interpretations. Using, this rubric, different teachers might well grade the same essay differently.

3. FACULTY EMPOWERMENT: Do faculty feel they have an active role to play in the test?

A. The top/down model that disempowers faculty: As the background information makes clear, faculty support is critical to effectively assess what students learn in college. In principle many faculty support accountability reforms that will improve student learning. But they do not necessarily view the above seven tests as representing a positive step forward. The tests often are part of a top/down structure that they are required to respond to but cannot direct—in respect to (a) how the tests were created, (b) how students prepare for them, (c) how they are graded, and/or (d) how the test results are handled.

In respect to faculty empowerment, CLA, NSSE, CAAP, Proficiency Profile. CCTST, and PISA are all top/down arrangements. Some outsider creates the test and grades it with minimal or no input from a school's faculty. An administrator at that school may then assess a faculty member's success as a teacher by the results of students who had her or him in a course. The stakes can be high, conceivably influencing a faculty member's chances for promotion. Students cannot usually prepare for these tests. The results may (or may not be made public depending, not infrequently, on how the scores influence a school's striving for status.

CAT is different in respect to grading. Faculty do not know the test questions before hand nor can they effectively prepare students for them. But faculty are actively involved in the grading process after students complete their tests. Several faculty sit around a table and collectively grade students' tests for several boars. To insure inter-rater reliability, two faculty grade the same test. If they agree on a certain score, the question is accepted as graded. If they disagree, the question is passed on to a third faculty member who grades the question again. The third faculty member's grade becomes the deciding factor in what score the answer receives. By being actively involved in the grading process, the hope is that faculty, seeing the strengths and limitations of students' critical thinking skills, will revise their curriculum. How often this occurs is unclear. But, according to the CAT, it certainly occurs.

B. Effectively Tracking Individual Student Progress: Most schools keep track of how individual students do. The CLA is an exception. Students take either the analytic essays or the performance task. They do not take both. To assess critical thinking and effective writing together, the scores from both groups are combined.

CLA claims that it can measure student progress by measuring a cohort of freshman and a cohort of seniors in the same year—on the assumption that the seniors were once freshman and the freshman will eventually become seniors. This, however, ignores the large number of transfers that occur at many schools. In some cases, a senior class may only contain 50% of the original freshman class. It is therefore a stretch to suggest any improvement in scores between the two cohorts results from a school's curriculum. A noticeable change might be the result of various transfers.

Schools use these tests to track a student's progress. But it is hard to hold a specific individual or program responsible for the test's results. A school ma test a student's critical thinking in the freshman year and then, again, in the student's senior year. The two tests may well provide a sense of the student's intellectual progress. But few have any idea aside from what individual students suggest which teachers, curricula and/or circumstances generated the resulting changes. Students deal with lots of teachers and take a range of courses in their four years. How does a school know which teachers or courses made a difference? Reasonably enough, many teachers, as a result, ask: Why give the tests—if they are not going to help improve student learning?

C. Focusing on formative rather than summative assessments: A formative assessment provides feedback that allows students to improve their performance before another test. A summative assessment describes a student's level of achievement at a certain point in time.

All seven tests are primarily used as summative assessments. They allow schools to learn what skills their students possess but not how to improve those skills. The one exception is NSSE. Not infrequently, deans reviewing their school's NSSE results, ask chairs who in turn ask faculty to raise the intellectual standards of their classes—by, for example, increasing the required readings, papers, or homework. The request is sometimes followed through on, sometimes not, depending on how much the dean and chairs support the effort. NSSE scores might well rise over a period of time. But it remains unclear whether higher NSSE scores mean a cohort of students have indeed improved in their critical thinking, problem solving and effective writing skills.

Why are the tests not used in a more formative manner? As noted, it is not clear what teachers, curricula and/or circumstances enhance results. If the tests were inexpensive and easy to give, they might be given every semester to ever student. That would then help clarify what conditions do, and do not, enhance better results. But few, if any, schools do that.

D. How the test results are handled: All the test results are provided to schools as statistics, which offer a sense of how various individuals and/or classes have done. Quite frequently schools strive to improve their standing in these tests vis-à-vis other “comparable” schools. But since certain schools do not make their scores public, it remains unclear exactly where in the status hierarchy various schools stand or how they have improved over time.

A test's scores are often provided to regional accreditors who frequently request them. But they are rarely used to assess whether a student or a cohort of students possess the necessary skills, say an 80% score on the ETS Proficiency Profile, to be graduated. Graduation is primarily determined by the number of course credits a student earns as well as whether the student's grade point average is above a certain level.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

### Overview

The principle advantage of the ACEP system and method is that it provides an avenue for testing and assessing critical thinking, which is specifically configured and designed to improve core educational proficiencies, and more effectively handles existing validity, reliability, and empowerment problems.

Another advantage of the ACEP system and method is that it is specifically Configured and designed to effectively assess learning, wherein ACEP's key elements require and reinforce one another so that they, as whole, are stronger and more effective than as individual elements.

And yet another advantage of the ACEP system and method is that there is a systematic fit in how the format used for assessing key skills (lengthy essays) allows for more sophisticated complex assessments that are also more valid and, moreover, can be scored in a more reliable manner, especially given the thorough training of the scoring engine and the effectiveness of the scoring engine itself.

Still another advantage is that it provides a way for students to readily see how they can improve their writing—making their essays clearer, better organized, and better documented in respect to the points being made.

### Validity

Yet a further advantage of the ACEP system and method is that the assessed critical thinking skills are divided into five sub-categories that precisely define the skills ACEP requires of students. In other words, critical thinking is not presented as a single category with a single overall score. The highlighted skills are taken from Bloom's Taxonomy, namely: (a) comprehension (understanding the key points of a text), (b) application (using knowledge from texts to address a problem than that is not referred to in the original text), (c) analysis (identifying causes, ranking them as to their significance, and finding evidence to support one's claims), (d) synthesis (combining information from texts in a new, innovative way to address a particular problem), and (e) evaluation (assessing and justifying judgements made regarding the above categories).

Another advantage of the ACEP system and method is that the testing effectively demonstrates if the student has mastered complex task assignments, often associated with Bloom's taxonomy and critical thinking and problem solving skills more generally.

Another advantage of the ACEP system and method is that the test questions, especially in comparison with other assessments, are not abstract, but focus on concrete problems of immediate concern to students thereby drawing them in to seriously addressing the questions presented. It also uses real documents students would likely encounter in investigating these problems.

Another advantage of the ACEP system and method is that, based on its questions and the answers students must formulate, it provides a reasonably valid assessment of whether students possess the critical thinking skills needed in everyday life. It also avoids requiring students to have some special background or major. Students are asked questions relating to (a) comprehension of reading material, (b) applying reading material to address problems in new contexts, (c) assessing significant causal relationships, (d) documenting a position, (e) offering an effective solution to a specific problem, (f) assessing the solution's effectiveness in the context presented and (g) suggesting ways to overcome problems that might impede the solution's implementation.

Yet another advantage of the ACEP system and method is, that prior to taking an assessment, students are given the basic framework and standards for that assessment. This allows students of diverse backgrounds to gain a sense of the test prior to taking it thereby facilitating those with limited testing experience to not be at a disadvantage in taking the assessment. They have a better idea of what to expect.

Students are assessed at two distinct points in time to assess what, if any, improvement they have made. Usually, the first assessment is given at the start of a student's major followed by a second assessment just prior to graduation. The advantage of focusing on majors, rather than the overall college experience, is because departments can be rewarded (and more broadly held accountable) for improved assessment scores.

Still another advantage of the ACEP system and method is that it is able to assess “soft skills” valued by employers, such as: Does the student answer the question that is asked (not respond to an unrelated question)? Does the student follow directions correctly? Does the student complete the test in the time specified?

Another advantage of the ACEP system and method is that the assessment—because it is based on Bloom's taxonomy and is relevant to a wide number of problems and contexts—is a more accurate barometer of critical thinking skills as used by prospective employers to assess a candidate's suitability for a position than assessments that focus on more narrowly framed skills.

And yet another advantage of the ACEP system and method is that a student may use the score as a certificate of merit indicating that he or she possesses the skills needed for a particular position.

Another advantage of the ACEP system and method is that it embodies more precise standards in respect to writing that focus on a set of key variables needed in any formal non-fiction writing, such as: whether the essay is clearly presented, well organized, and properly documented. The focus is on variables students well understand and need in their post-graduate careers.

Another advantage of the ACEP system and method is that it provides for scoring of grammar, vocabulary and spelling using a separate software program.

Another advantage of the ACEP system and method is that, among its projected users—especially college administrators and faculty—it possesses a fairly high sense of face validity for its questions and answers relating to the learning skills it seeks to assess. Many faculty concur that an open ended format with high level questions and lengthy answers fits better with their sense of how to assess critical thinking than those based on multiple choice or short answer formats. In addition, ACEP furthers this perception by providing students with their own individual scores on individual variables, rather than summating them into a single individual or group score.

And yet another advantage of the ACEP system and method is that given ACEP's lengthy essay format and its open-ended answers, it is fairly hard to cheat.

### Reliability

Another advantage of the ACEP system and method is that it an option exists for two separate assessments taken within a week's time, with both assessments requiring three separate essays, each having a more than 900 words total per assessment. This insures greater reliability on high-valued assessments.

Yet another advantage of the ACEP system and method is that when two separate assessments are taken within a week's time, they are separated by a minimum of 48 hours. This allows students to feel refreshed when taking the second assessment.

Yet another advantage of the ACEP system and method is that the two assessment tests may last up to a total of 8 hours, with each assessment lasting up to 4 hours. Most students average about three hours per assessment, with a number taking the full four hours of time allotted.

A further advantage of the ACEP system and method is that the testing is administered remotely via a global computer network such as the Internet.

Another advantage of the ACEP system and method is that the completed assessments for each student are automatically submitted to a propriety scoring engine that avoids many of the problems—such as variation and slow turn-around times—inherent in individual teachers grading the assessments. All students taking the assessments are graded on the same standards independent of individual teachers and schools.

### Faculty Empowerment

Another advantage of the ACEP system and method is that ACEP empowers teachers to ensure students gain the general critical thinking, problem solving, and writing skills they need for successful careers and meaningful lives following graduation.

Yet another advantage of the ACEP system and method is that ACEP demonstrates the faculty's competence as teachers and uses a bonus reward system that rewards departments when students improve between initial and final assessments.

Another advantage of the ACEP system and method is that faculty can collectively decide how many critical thinking, problem solving, and effective writing skills need reach a certain level by graduation to demonstrate a student's educational proficiency and competence.

And yet another advantage of the ACEP system and method is that in presenting a score for each of the assessed skills, it detects what particular skill is not mastered and adds what needs to be focused on to achieve mastery in that skill, especially before the pre-graduation assessment.

Another advantage of the ACEP system and method is that it provides for tracking a student's improvement over a period of time, as it involves the two distinct assessments being given at different times—a year or two apart.

Another advantage of the ACEP system and method is that students receive a code that allows them to log into a website and (1) see the skills the student is strong and weak in and (2) what steps might reasonably be taken to improve the student's skills.

Another advantage of the ACEP system and method is that by the way it is constructed and graded, it focuses on formative rather than summative assessment. This guides teachers in helping ensure graduating students have the skills they are supposed to possess on graduation.

### Highlighting ACEP's Special Advantages

There are two primary advantages to ACEP over the seven tests discussed above. First, it more effectively handles existing, validity, reliability, and empowerment problems. Second, ACEP's key elements require and reinforce one another so that they, as a whole, are stronger and more effective than as individual elements.

1. VALIDITY: Do the tests accurately assess critical thinking, problem solving and effective writing?

A. What constitutes critical thinking—focusing on post-graduation every day and career problems: In respect to validity, ACEP is organized—with its five documents and three questions—to parallel the types of questions graduates will deal with in their careers. It focuses on concrete problems of immediate concern to the students such as why does college cost so much? No other test focuses as clearly on problems of such direct interest to students. In doing so, it avoids requiring students to have some special background drawn from a major other than their own. The problems—such as the reasons why college costs so much—concern the vast majority of test takers ACEP also uses actual documents (in abridged form) from new media such as the Washington Post, Inside Higher Ed and The Chronicle of Higher Education, media that students would likely read if they were investigating the problem being studied in some depth.

ACEP requires students to answer questions relating to (a) comprehension of the reading material, (b) applying information drawn from the reading, material to address related problems in new contexts, (c) assessing significant causal relationships, (d) documenting a position, (e) offering an effective solution to a specific problem, (f) assessing the solution's effectiveness in the context presented and (g) suggesting ways to overcome problems that might impede the solution's implementation.

Many faculty would readily concur that ACEP possesses face validity for its questions and answers relating to the learning skills it seeks to assess. The questions deal with interpreting various data, formulating solutions to problems and deciding which solution might work best under what conditions, as well as how to specifically implement a particular solution. The essays allow for open, ambiguous and divergent responses that many faculty would perceive, unlike multiple choice answers, as appropriate to the task. Answering the questions in a written essay format makes sense to most faculty as a valid way to assess critical thinking, problem solving and effective writing, as well as real life documents rather than fabricated ones.

B. Critical thinking, problem solving and writing should he assessed together: Because ACEP's questions involve open, diverse, complicated and ambiguous answers, they cannot be responded to by clicking on one of five multiple choice alternatives. ACEP, with its three questions and 300-word requirement per question (or 900 words total per assessment) involves the option for two assessments taken within a week's time (which means the total test involves a total of at least 1800 words). It is unique in how it requires such extensive, thoughtful essays relating to real life problems of the type that students will likely encounter following graduation.

Critical thinking skills are divided into five sub-categories that precisely define the skills ACEP requires of students. In other words, critical thinking is not presented as a single category with a single overall score. The highlighted skills are taken from Bloom's Taxonomy, namely: (a) comprehension (understanding the key points of a text), (b) application (using knowledge from texts to address a problem than that is not referred to in the original text), (c) analysis (identifying causes, ranking them as to their significance, and finding evidence to support one's claims), (d) synthesis (combining information from texts in a new, innovative way to address a particular problem), and (e) evaluation (assessing and justifying judgements made regarding the above categories). In respect to writing, the focus is on a set of key variables needed in any formal non-fiction writing such as: (a) whether the essay is clearly presented, (b) well organized, and (c) properly documented. The focus is on variables students well understand and need in their post-graduate careers. In addition, ACEP scores (d) grammar, (e) vocabulary and (f) spelling using a proprietary software program.

C. Do the questions motivate students to provide thoughtful, comprehensive answers? Because ACEP deals with real life problems of direct interest to students, students generally feel motivated to address them, in a trial run of more than 450 students, well over 90% of the students completed the 300-word requirement per essay. A number of essays were 500-700 words in length. Most students averaged about three hours per assessment. A sizeable number take the full four hours. In brief, the students seem quite motivated to read about and address the problem raised because they are problems that very much concern them.

D. Having a single overall score versus multiple distinct score: Rather than provide a single, overall score, as noted above (in paragraph [0086]), ACEP assesses critical thinking and problem solving along five traits embodied in Bloom's taxonomy. In addition, it focuses on six traits in respect to writing. ACEP also assesses what it terms “task management” skills valued by employer. This involves: Does the student answer the question that is asked (not respond to an unrelated question)? Does the student follow directions correctly? Does the student complete the test in the time specified? None of the others tests provide test results that allow someone to assess such “soft skills.” In fact, we would suggest that students are tracked on a larger number of skills than any of the seven tests discussed. This is a unique attribute of ACEP.

2. RELIABILITY: Do the tests repeatedly yield the same results?

A. Having more than one test to ensure reliability: ACEP may involve two tests taken within one week's time but not taken on the same day (so as not to exhaust students). Moreover, many of the skills highlighted in one question are also highlighted in others so a particular skill will likely be assessed a number of times per test.

B. Reducing variations in grading, especially in essays: ACEP is particularly effective in grading essays due to its propriety grading engine. Despite focusing on essays—rather than multiple choice—it reduces the widely observed variation in how teachers grade essays. Through a feedback process, the parameters used in machine scoring of answers are repeatedly refined until they offer a fair, balanced representation of students' answers vis-à-vis the questions asked. Assessments of the above specified skills are ranked, with each skill having a particular set of steps. The goal is to be sensitive to how each skill is assessed rather than focus on an across the board set of standards.

ETS Proficiency Profile, CLA and ACEP all make use of automatic scoring engines for machine grading). ACEP, however, is unique in the use of extended essays with a propriety scoring engine sensitive to subtle differences in skills and student answers. The way specific answers are grouped into larger wholes, for example, depends on the topic, the range of student abilities, essays, and the skills assessed. It depends, in brief, on how students' respond rather than on a pre-assumed approach. Some scoring engines, such as one used by ETS, parse a sentence and then assess if and where these parts appear in a sentence. Parsing may work reasonably well for assessing grammar, but it does not work as well for assessing critical thinking and problem solving.

3. FACULTY EMPOWERMENT: Do faculty feet have an active role to play in the test?

A. The top/down model that empowers fact ACEP, like the other tests, has a top-down model for how the test is formulated. The questions and documents are selected for those taking the test. Similarly, grading is beyond the faculty's control.

But faculty know in advance what the ACEP tests generally look like and, as a result, ran effectively prepare their students for it. Teachers can adjust their curriculum appropriately. In “teaching to the test” faculty are, in fact, teaching their students the key critical thinking, problem solving and effective writing skills they will need following graduation.

In giving up control over some parts of ACEP, a school's faculty gain something important in return—credible results. Faculty can demonstrate to the broader public, potential employers of their students, politicians, and/or school administrators that their students have indeed reached a certain level of skill development.

B. Effectively Tracking Student Progress: Rather than emphasizing how one school compares with another, ACEP focuses on whether a student has reached a certain skill level. This means that in tracking improvement over a period of time, ACEP can also be used as an exit exam that ensures all graduating students do, indeed, have the skills they are supposed to possess at graduation. A student can also use his or her ACEP score as a certificate of merit indicating she or he possesses the skills needed for a particular position.

C. Focusing on formative rather than summative assessments: Through its focus on formative (rather than summative) assessments, ACEP provides specific details and examples for how students can improve. As noted in 1B above, no other test does this to the same degree. Students receive a code that allows them to log into a website and (1) see the skills the student is strong and weak in as well as (2) what steps might reasonably be taken to improve the student's skills.

In empowering students through feedback, ACEP not only helps students improve through time but also empowers faculty. The formative focus encourages faculty to practice with their students for an assessment with related documents and problems. Like the CAT, faculty can grade these practice tests and highlight what students need to specifically learn to improve their skills.

This formative focus highlight's another of ACEP's distinctive features. Given its lengthy essay format and its open ended answers, it is fairly hard to cheat. There are no “correct” answers. Students are given the basic questions before hand (though not the documents). This allows students to prepare for the test. It also helps those with limited testing experience to not be at a disadvantage. They know what to expect. If a student “cheats” by mastering beforehand the skills needed to do well, then in effect the student has mastered the critical skills being assessed. Teachers teaching to the test, from this perspective, constitute a pedagogically positive approach.

D. How the Test Results Are Handled:

Many schools use one or more of the seven tests less as a signifier that a student has mastered certain skills (and therefore can graduate), as comparative markers of how the school's students—and by implication the school itself—stands in relation to other schools. This means faculty may get drawn into a status treadmill rather than focusing on their students mastering the key skills they will need for successful careers following graduation.

ACEP deemphasizes how one group compares with another group. It instead focuses on whether individual students have achieved a certain skill level.

Faculty are empowered by the fact that they can collectively decide how many critical thinking, problem solving, and effective writing skills need be reached at what levels to demonstrate educational proficiency and competence. Over several decades, faculty have tended to lose this power. As it stands, a student's credit hours and grade point average have become the crucial determinants for graduation. There is no reason faculty could not decide that they want students to reach a certain level on a set of skills in order to be graduated.

By demonstrating to the broader public, politicians, and school administrators that their students have reached a certain level of skill development, ACEP emphasizes a faculty's competence as teachers. Speaking in broad terms, one might say that ACEP empowers students (by ensuring they possess key skills), the broader public (by ensuring certain educational standards are met), and the faculty (by allowing them to actively participate in the process in a way that empowers them and allows them to demonstrate their competence as teachers) The metrics and transparency fostered by ACEP empowers all three constituencies.

E. How the Bonus Reward System Operates:

If students raise their ACEP scores over time—between starting and completing their major—then why shouldn't the teachers, who helped them, be rewarded? It emphasizes that focusing on improvement is more than a platitude. It is central to what the school seeks to achieve.

It is expected that ACEP will likely cost fifteen dollars per student. Developing the software to run the system as well as use propriety scoring engine will take five dollars of that money. Another five dollars will be used to cover marketing and support costs. The third five dollars will constitute a bonus pot. When a student raises his or her scores in subsequent tests, the department in which the student majors—hence presumably the one in which the student has taken the most courses (because of his or her major)—receives the five dollars. In a class of 7,500 students, if ⅔rds of the students improved on their ACEP scores in a particular year, that would mean $25,000 would be donated to the relevant departments—giving these departments a major reason to focus on improving critical thinking, problem-solving, and writing skills.

4. The Sum is Greater Than its Parts: How Various Elements of the Test Are Entwined:

ACEP also differs from other tests in a more basic way. Different elements of the test directly support one another. There is a systematic fit in how the format used for assessing key skills (lengthy essays) allows for more sophisticated complicated assessments that are also more valid and, moreover, can be scored in a more reliable manner, especially given the thorough training of the scoring engine and the effectiveness of the scoring engine itself. Because the questions involve complex issues—such as why college costs so much—they tend to hold students' interest despite the lengthy writing requirement and, importantly, relate fairly closely to the contexts in which students will apply their skills following graduation.

Teachers are central to the ACEP project. ACEP's face validity fits with what most teachers view as critical thinking and how it should be measured. By encouraging “teaching to the test” regarding what teachers view as the most central skill students need gain in college and by providing bonuses to teachers who raise their students' scores for a test assessing this skill, a college's faculty may have a greater sense of empowerment even when there is a top/down decision-making process at their school.

The school administration will likely support the faculty since it also benefits. Because ACEP relies on an automatic scoring engine, teachers need not worry about grading but can, instead, focus on helping students learn. In being empowered by ACEP, teachers become the energy behind it. They insure students gain the skills they need for successful careers and meaningful lives following graduation.

It must be clearly understood at this time although the preferred embodiment of the invention consists of the ACEP critical thinking assessment test system and method, that many configurations of same, or combinations thereof, that will be configured similarly, and achieve a similar operation and they will also be fully covered within the scope of this patent.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention,

FIG. 1 depicts the overall processes of the ACEP testing system;

FIG. 2 depicts the ACEP training process, a method by which auto-graders are prepared for grading specific tests;

FIG. 3 depicts the test development process, a method by which each test is developed;

FIG. 4 depicts the ACEP cycle of testing;

FIG. 5 depicts the users experience of taking ACEP tests;

FIG. 6 depicts the physical components of the ACEP process;

FIG. 7 depicts a computer or another electronic device screen shot which illustrates the screen that opens when the user logs on to the deweyproject.net website;

FIG. 8 depicts a computer or another electronic device screen shot which illustrates the CREATE NEW ACCOUNT pate as accessed from the home page;

FIG. 9 depicts a computer or another electronic device screen shot which shows an extension of CREATE NEW ACCOUNT process, alerting the user that the verification code has been sent;

FIG. 10 depicts an illustration of the verification email transmitted to the student;

FIG. 11 depicts a computer or another electronic device screen shot which is the introductory screen to the test; and

FIG. 12 depicts an illustration of the display of the test proper, including test questions and test documents.

### DETAILED DESCRIPTION OF THE PREFERRED EMBODIMENTS

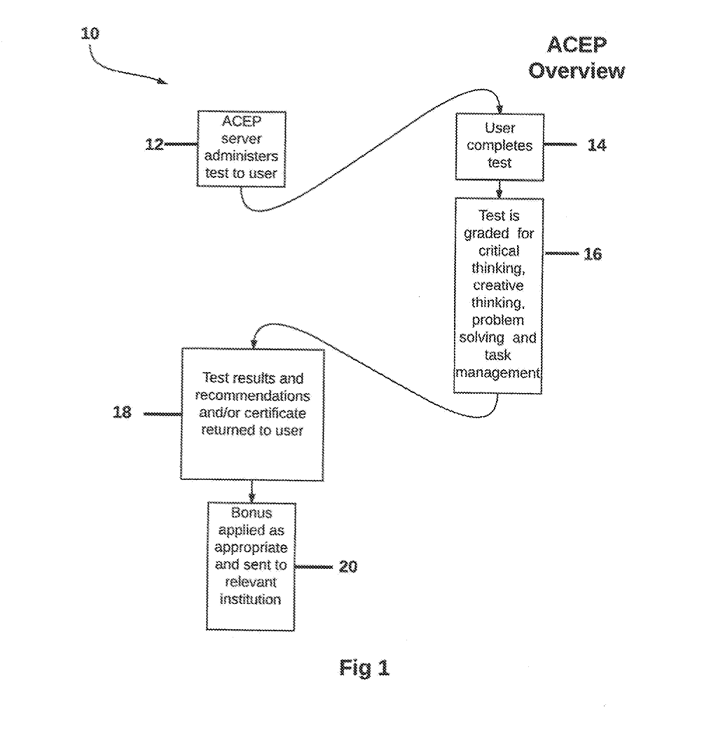

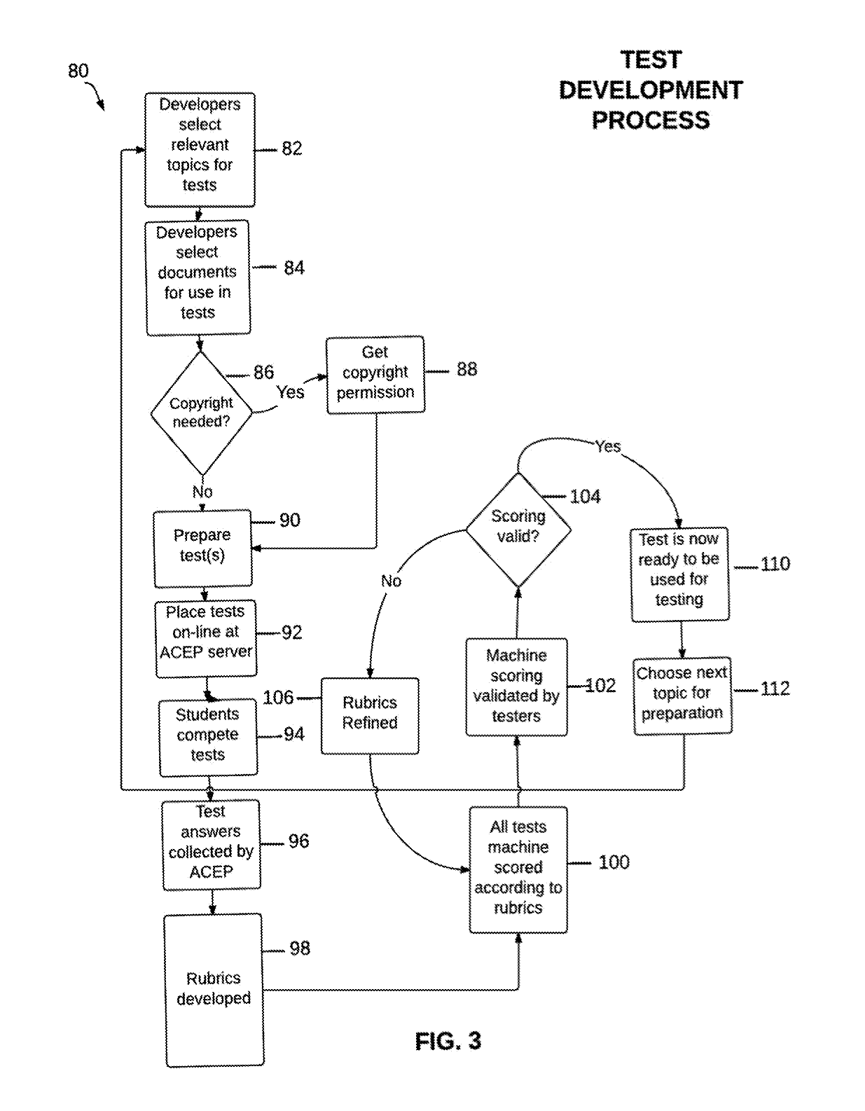

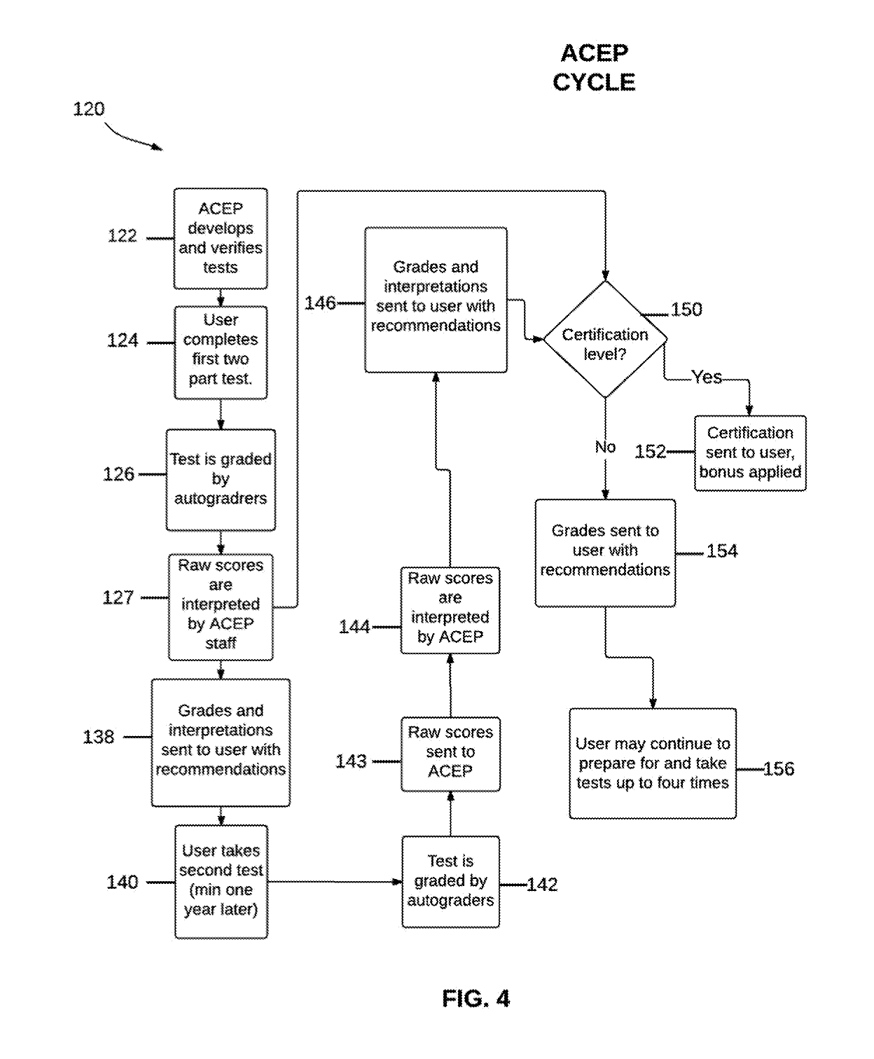

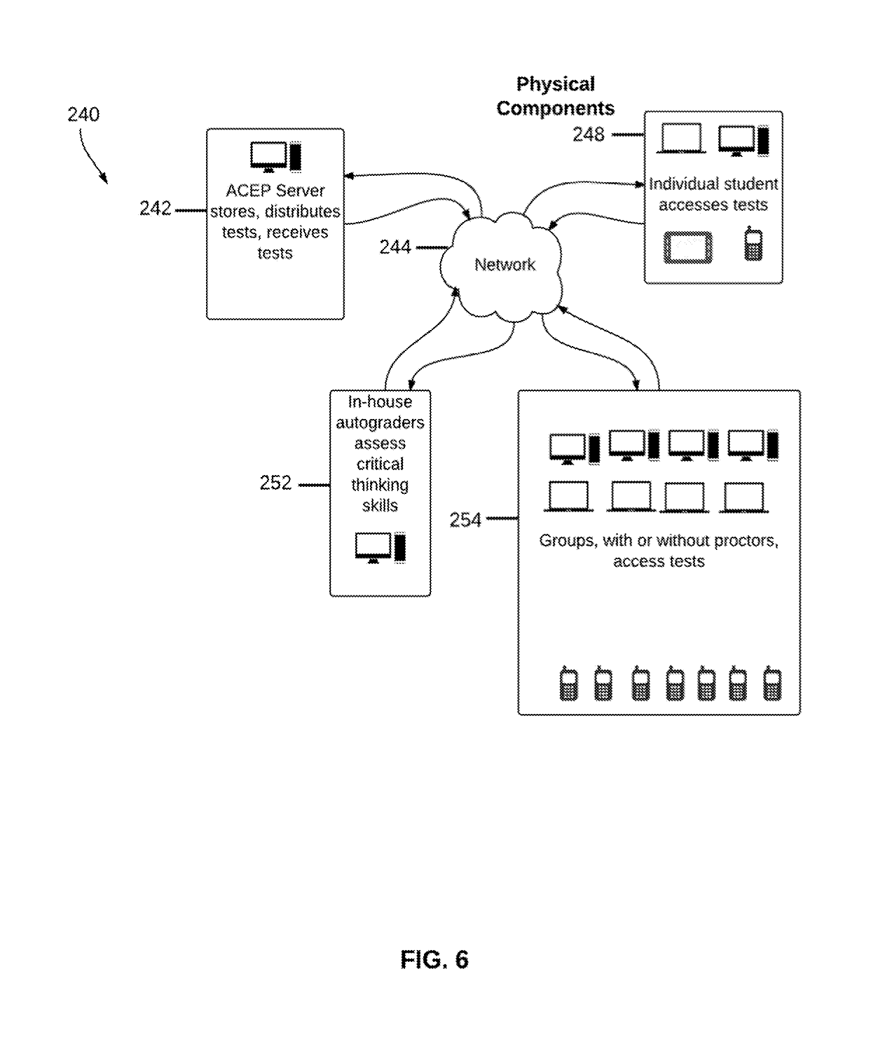

For a fuller understanding of the nature and objects of the invention, reference should be had to the following detailed description taken in conjunction with the accompanying drawings wherein similar parts of the invention are identified by like reference numerals. There is seen in FIG. 1 an illustration of the overall processes of the ACEP testing system 10. The ACEP server 12 holds tests which have been validated as shown and described below in FIG. 3, ACEP electronically distributes tests to users 14 who complete the tests and submit them for grading, communications being received and sent as shown and described below in FIG. 6. Each test is made up of two parts to be taken one to two days apart. Tests are graded electronically by proprietary software and by third-party vendors 16. The latter grades for certain criteria including but not limited to critical thinking, creative thinking, problem solving, effective writing and task management. The third party vendors send results to the ACEP testing system 10. ACEP interprets the tests based on the above results. Results are then sent to the user with recommendations for improving future results or, if Certification levels have been reached, as shown and described below in FIG. 4, with a certificate noting that the user has attained certification levels in all the criteria evaluated.

The bonus system 20, affirms ACEP's focus on empowering faculty. Often assessment tests obscure which teachers under what conditions helped students improve (see paragraph [0043]). By focusing its assessments at the start and end of a major, ACEP affirms faculty accountability. It tracks which specific teachers helped a student progress. The bonus system stresses that, with such accountability, comes financial rewards for faculty who help students improve. The bonus system, in brief, reinforces ACEP's formative focus and encourages faculty to shine as teachers.

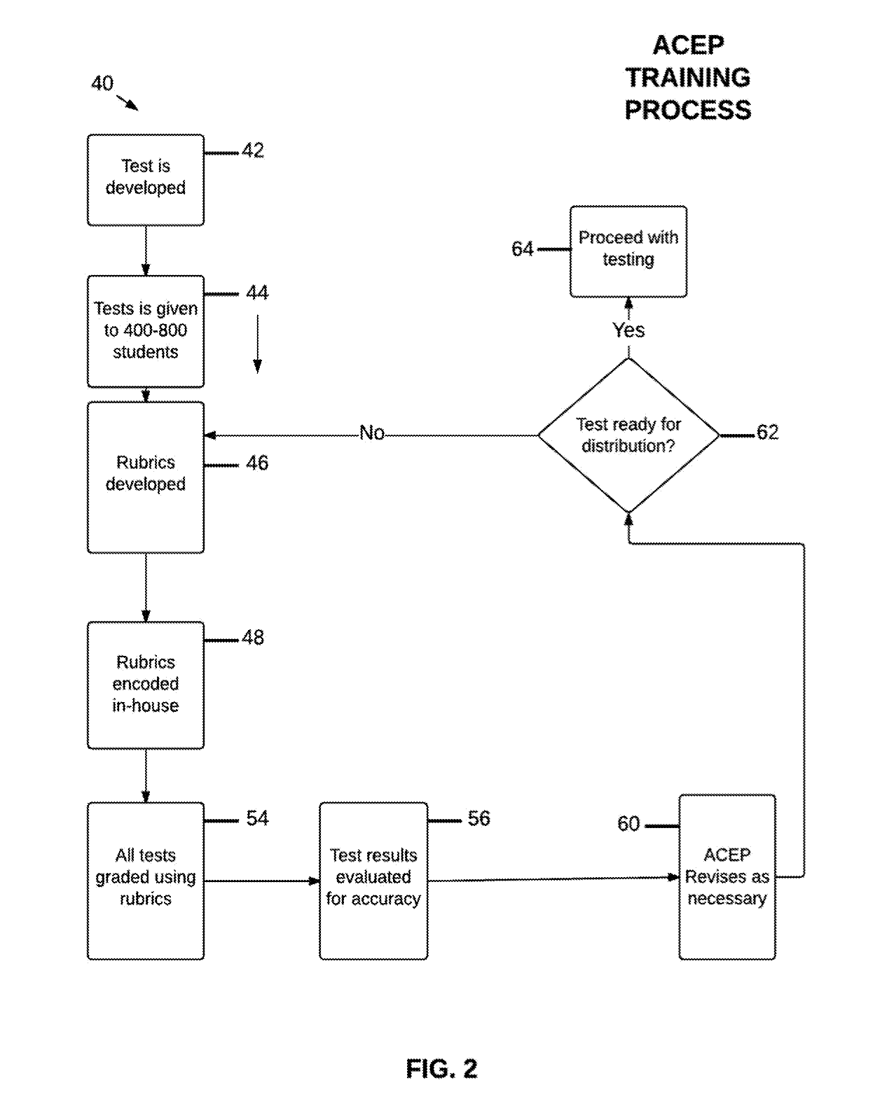

FIG. 2 illustrates the ACEP training process 40, a method by which auto-graders are prepared for grading, specific tests. Once tests have been developed 42, as shown and described below in FIG. 3, between 400 and 800 actual, completed tests are acquired from university students across the country for use in training the auto-graders 44. The rubrics are developed using a sample of at least 50 tests 46. These rubrics are then encoded 48. Rubrics are then used to machine-grade the entire sample of 400-800 tests 54, after which the machine results are reviewed in extensive detail for accuracy and thoroughness 56. As necessary the rubrics are revised to ensure machine-grading effectiveness 60. Once the tests and grading procedures are confirmed ready 62, should more work be required in either the test wording or other detail, the testing process would recommence. Otherwise the testing then proceeds on an on-demand basis 64.

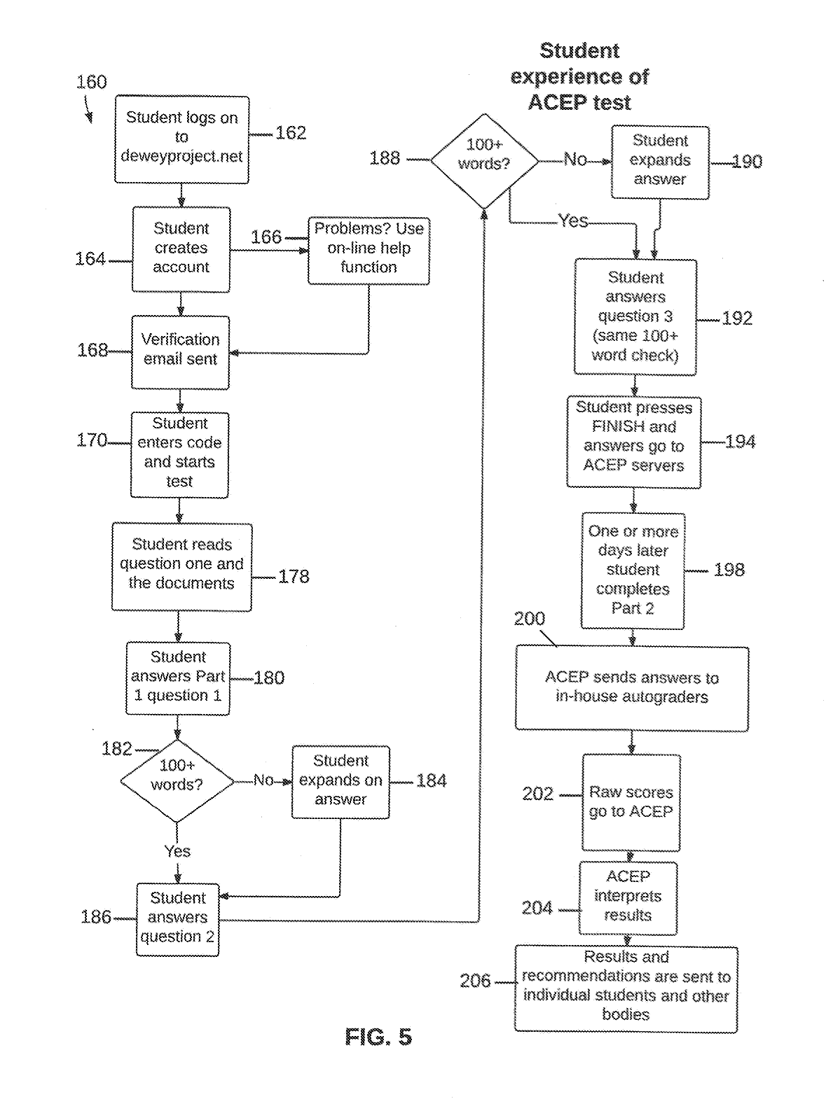

FIG. 3 illustrates the test development process 80, a method by which each test is developed. This is a very extensive process and is underway continually as new tests are developed. Developers first select a relevant topic for each test 82. Such topics as are selected are of immediate interest to students in a college setting, and include but are not limited to an examination of college costs, issues surrounding college retention and the like. Once the general topic has been selected, a search is done for actual “real-world” published documents 84 relating to the issue at hand. If the documents are protected by copyright 86 then copyright permission is acquired 88. Currently five documents are prepared for each test with three questions asked on each test 90. The tests are trial tested and evaluated in accordance with FIG. 2, the ACEP Training Process. Tests including documentation are then placed on the ACEP server 92 for network delivery as required by demand. Student can then access the tests on-line and complete them 94 as described below in FIG. 5, Student Experience of the ACEP Test. ACEP Test answers are then submitted to ACEP 96. The rubrics are then created 98 and used in-house to machine score all tests 100. Grading is validated in-house 102. If the scoring is deemed inadequate 104 rubrics are further refined and re-tested 106. Once scoring is validated the test is deemed ready for use 110, and the next topic for preparation is selected 112 and the process begins again 82.

FIG. 4 illustrates the ACEP cycle of testing 120. ACEP prepares a two-part test 122 which the user(s) then complete 124 as described below in FIG. 5. The test is graded by ACEP auto-graders 126 and the grades are sent to ACEP, interpreted by ACEP staff 127, and sent with recommendations to the user 138. In the event that the user has scored at certification level 150 a certificate can be issued 152 and that user is considered to have completed the ACEP process of FIG. 1. In most cases the user will take a second, different test approximately one or two years after the first 140 test. This next test is graded by ACEP auto-graders 142, the scores are sent to ACEP 143 and interpreted 144, and then sent to users 146. A determination of certifiability 150 is made, and if appropriate, certification is sent to the user 152 and the bonus is applied. In the event the user has not yet reached certification level, then as before the grades and recommendations for improvement are sent to the user 154. The user may continue to prepare for and take tests a number of times 156 (currently as many as four times) as illustrated in FIG. 4.

The bonus system, affirms ACEP's focus on empowering, faculty. Often assessment tests obscure which teachers under what conditions helped students improve (see paragraph [0043]). By focusing its assessments at the start and end of a major, ACEP affirms faculty accountability. It tracks which specific teachers helped a student progress. The bonus system stresses that, with such accountability, comes financial rewards for faculty who help students improve. The bonus system, in brief, reinforces ACEP's formative focus and encourages faculty to shine as teachers.

FIG. 5 illustrates the users' experience of taking ACEP tests 160. The user logs onto the appropriate website 162 (currently shown as deweyproject.net) and creates art account 164. Any difficulties in this process can be resolved using the on-line help function 166. A verification email is transmitted 168 which includes a code that the student uses 170 to further access the testing website. The student examines both the on line documentation and questions 178, and then answers question 1 of that test 180. The essay answer must be 100 words or more 182. In the event this is not the case the student is advised of that and is provided the opportunity to expand the answer 184. Once that question is complete the student answers the second question 186. Once again the word count is checked 188, and, if short, the student lengthens the answer before proceeding further 190. The student then addresses the third question 192, which has the same one hundred-word requirement 182. Answers are automatically saved to the ACEP server every three minutes, and when the test is complete the user indicates FINISH 194. The answers are saved on the ACEP server 194. One to two days later (ideally two) the student repeats the process with the second part of the test 198. Once ACEP has both sets of answers, they are sent to auto-graders 200 for grading. The results of these grading processes are returned to ACEP 202 which interprets the results 204, calculating scores and sub-scores for each of the skills tested including but not limited to critical thinking, creative thinking, problem solving, effective writing and task management. Results and recommendations are sent on to individual users, Universities or other bodies as appropriate 206.

FIG. 6 illustrates the physical components of the ACEP process 240. The ACEP server(s) store, distribute and receive tests 242. It connects to a network 244, one of many global computer networks, such as the Internet. Individual users 248 access, complete and submit tests using any of a variety of electronic means including but not limited to desktop computers, laptops, smartphones and other such devices. Responses are sent to the network 244, and are then forwarded to auto-grading systems, in this case proprietary software which assesses the responses for creative thinking, problem solving, effective writing and task management. In a similar fashion tests may be accessed by groups of students 254.

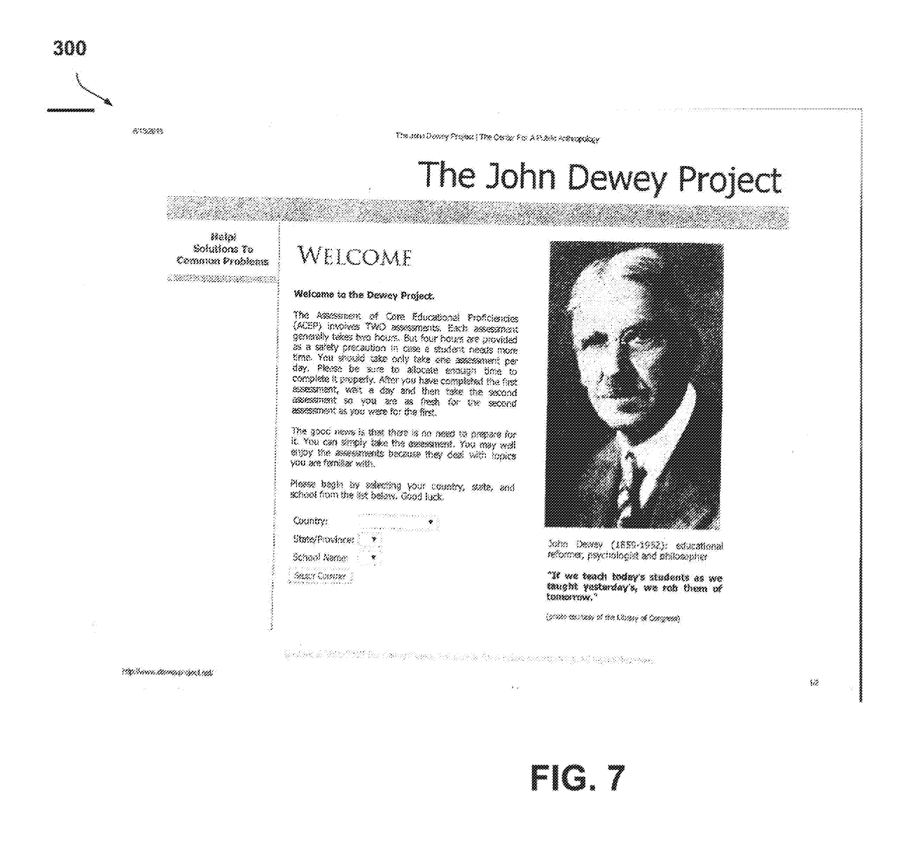

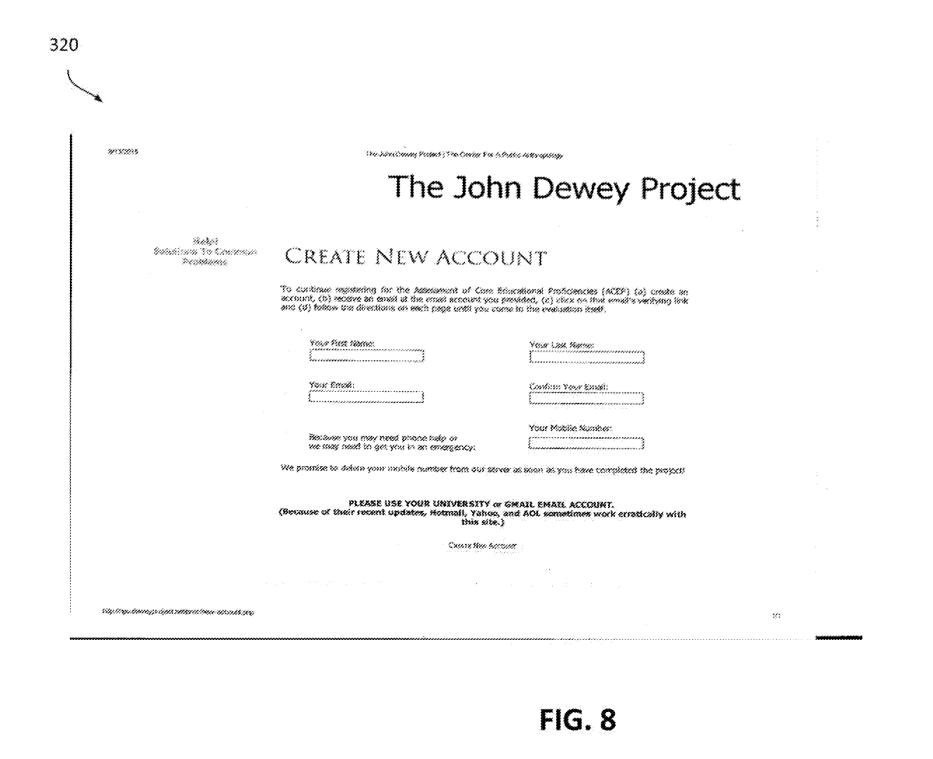

FIG. 7 illustrates the screen that opens when the user logs on to the deweyproject.net website 300. On this page the user selects from a drop-down list his or her country, State or Province, and School Name. As each step is completed the button SELECT COUNTRY, shown on the screenshot, changes to CHOOSE STATE/PROV, then CHOOSE SCHOOL NAME and ultimately to PARTICIPATING! CONTINUE. The user clicks on this button and is taken to the next page shown below. FIG. 8, CREATE NEW ACCOUNT.

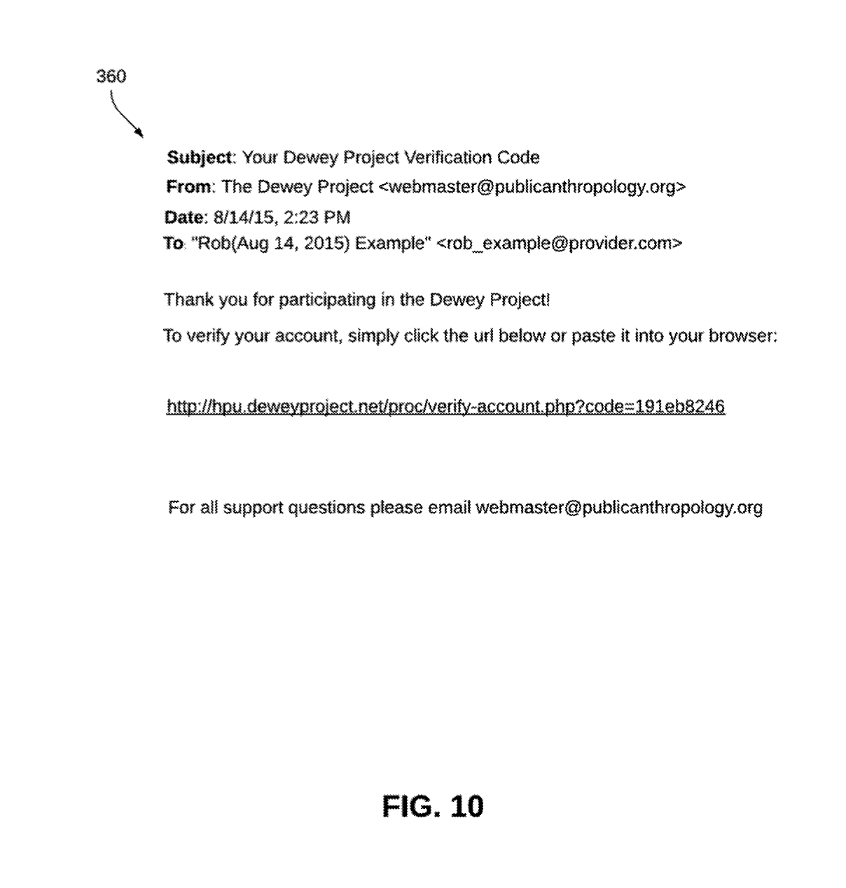

FIG. 8 Illustrates the CREATE NEW ACCOUNT page 320 accessed from FIG. 7 above. On this page the user enters his or her first and last names, their email address and a confirmation of the email, and a mobile cell number or other method of smartphone communication. Having completed this, the user clicks on the CREATE NEW ACCOUNT button at the bottom of the page. At this point a verification e-mail is generated and sent to the user's email address as shown below in FIG. 10.

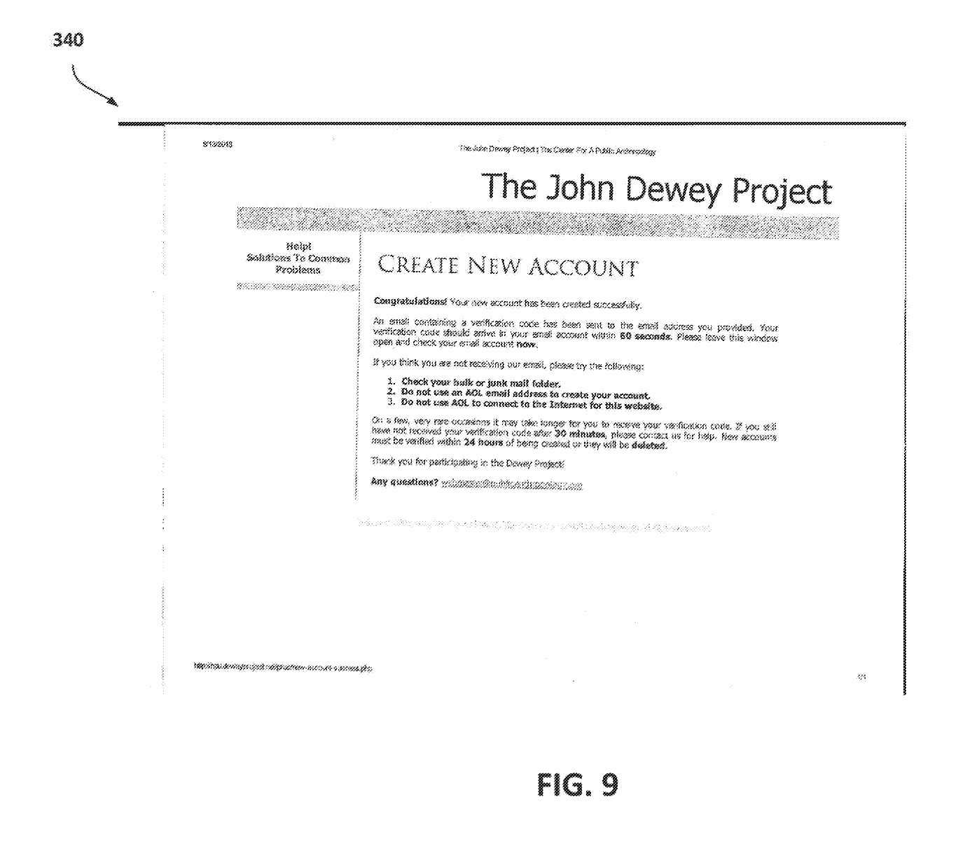

FIG. 9 shows an extension of CREATE NEW ACCOUNT process 340, alerting the user that the verification has been sent. A verification email is immediately sent to the user, as shown below in FIG. 10.

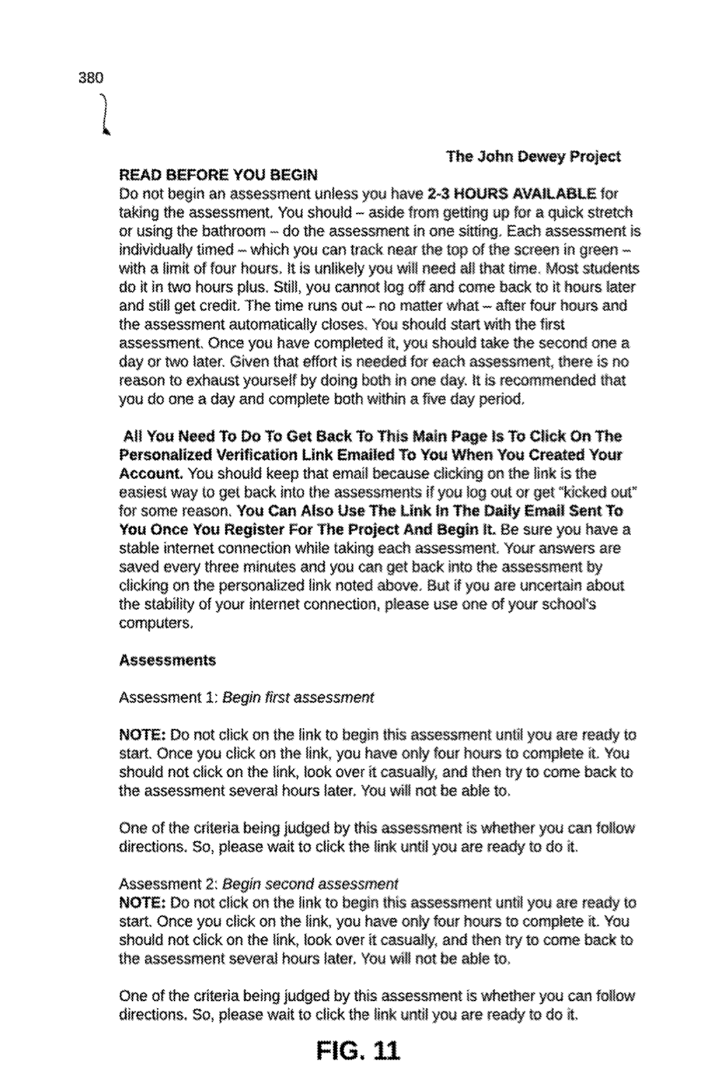

FIG. 10 illustrates the verification email entailed to the student 360. On it is a link which, when clicked, takes the user to the test introductory screen as shown below in FIG. 11.

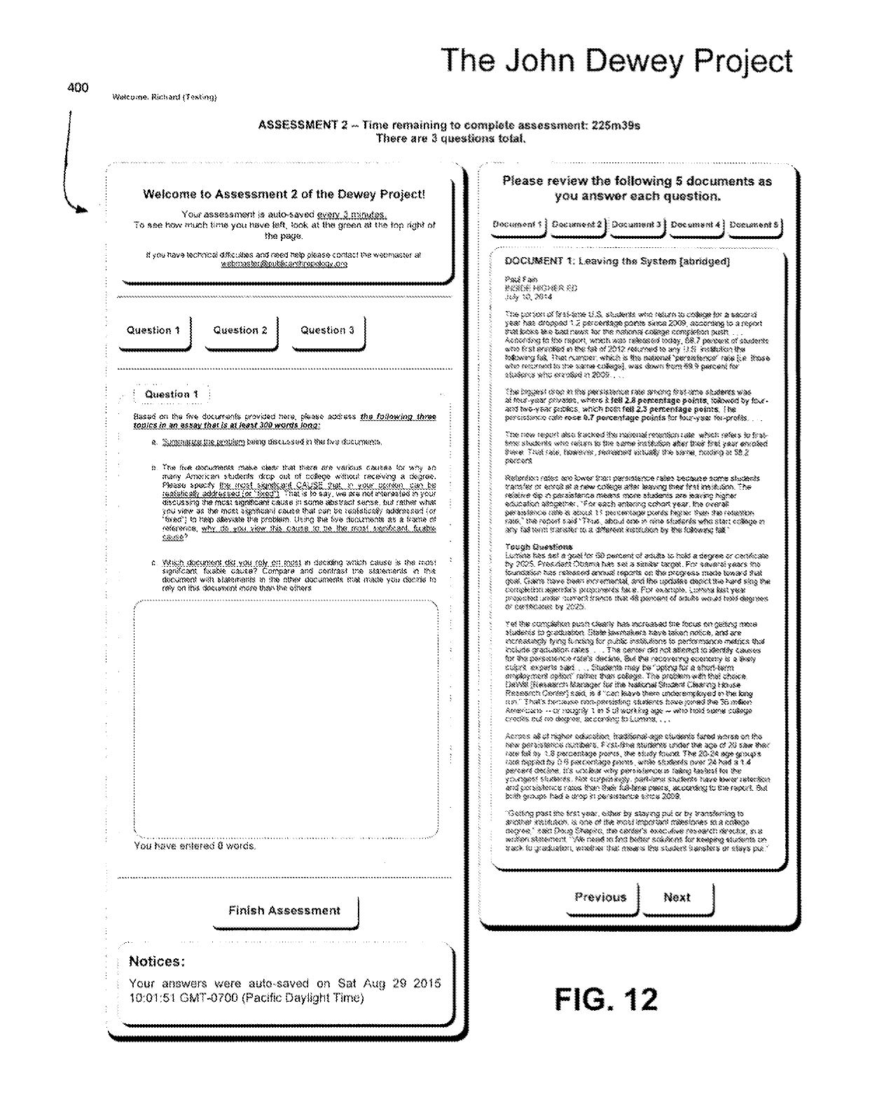

FIG. 11 is the introductory screen to the test 380. It lays out the general directions including time specifications. Below the instructions are buttons which the user will click to select the assessment to be taken. The present screen shows two possibilities, but updated versions may include as many as four or more possible assessments. Clicking on the appropriate assessment takes the user to the test proper, which is illustrated in FIG. 12 below.

FIG. 12 illustrates the display of the test proper 400. Users select which question to answer, which they then answer by composing an essay in the essay box provided on the left-hand side of the screen. The documents that are to be referenced in composing the answer are displayed on the right hand of the screen. As words are entered, the word count is displayed below the essay box. Once all questions have been answered, the user clicks the FINISH ASSESSMENT button and the test being taken is closed. Note that a user may elect not to answer every question, in full or in part, and this decision will be reflected in that part of the evaluation dealing with task management. The test is halted automatically by the system after four hours from the starting point.

Some of the more important features and advantages of the present invention are: the standards it uses to assess critical thinking and problem solving; the extensive preparatory work done in writing and testing rubrics for the auto-graders.

When combined with the two test format, ACEP provides the most detailed, thorough, transparent assessment of the skills that, collectively, constitute critical thinking and problem solving. ACEP, for example, assesses how well a student (1) addresses the question asked, (2) summarizes the basic problem the documents address, (3) interprets information in the documents without inappropriate references, (4) recognizes valid inferences from specific data. (5) identifies invalid inferences, (6) identifies the problem needing to be solved, (7) generates a number of possible ideas or alternative possibilities, (8) argues from different points of view, (9) takes an idea and elaborates on the idea's possibilities (including what would happen if a trend continued), (10) justifies a choice by stressing the most supportive document for that choice, (11) indicates specific data in the document that supports this choice, (12) identifies which documents were less relied on, (13) specifies in detail the qualities that made some documents superior to the others for addressing certain problems, (14) recognizes valid sources for various statements, (15) assesses how strongly specific data support a particular assertion, (16) cites evidence needed to support a specific statement, (17) states whether potential solutions offered to address a problem are plausible, (18) specifies steps needed to effectively address the problem being discussed, (19) offers a possibility no one else has suggests, (20) identifies one or more strengths of the two potential solutions offered, (21) identifies one or more weaknesses of the two solutions offered, (22) cites relevant documents that support one or both solutions, (23) indicates how strongly data in the documents support one or the other of the solutions, and (24) assess to what degree the student persists with and completes the assigned task.

Over fifty fully graded essays are fed into the scoring engine to train it so it perceives common patterns for what constitutes a specific score for particular skill.

ACEP (a) ensures that the scoring engine can effectively differentiate between the levels of a particular skill which means that, when combined with (b) the large training sample of essays, and (c) the proven accuracy of the scoring engine at differentiating levels, the scoring engine is reliable at replicating the training patterns of the teachers who trained the scoring engine.

The teachers involved in the training each have over 30 years of teaching experience. They both have advanced teaching certificates.

Faculty know in advance what the ACEP tests generally look like and, as a result, can effectively prepare their students for it. In “teaching' to the test” faculty are teaching their students the key critical thinking, problem solving and effective writing skills they will need following graduation.

Focusing on formative rather than summative assessments:
a) ACEP provides specific details and examples for how students can improve;
b) ACEP demonstrates the faculty's competence as teachers; and
c) there is a systematic fit in how the format used for assessing key skills (lengthy essays) allows for more sophisticated complicated assessments that are also more valid and, moreover, can be scored in a more reliable manner, especially given the thorough training of the scoring engine and the effectiveness of the scoring engine itself.

The system and method for assessment of core educational proficiencies 10 shown in the drawings and described in detail herein disclose arrangements of elements of particular construction and configuration for illustrating preferred embodiments of structure and method of operation of the present invention, it is to be understood however, that elements of different construction and configuration and other arrangements thereof, other than those illustrated and described may be employed for providing a system and method for assessment of core educational proficiencies 10 in accordance with the spirit of the invention, and such changes, alternations and modifications as would occur to those skilled in the art are considered to be within the scope of this invention as broadly defined in the appended claims.

Further, the purpose of the foregoing abstract is to enable the US Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A web-based computer implemented system for assessment of core educational proficiencies (ACEP) comprising:
a) a computer network including one or more dedicated servers, wherein said servers having data storage, memory and display devices configured to develop, control, deploy, operate and administer an assessment testing system and process;
b) said assessment testing system comprising a first test and a second test wherein said first test and said second test each include three essay questions to be answered by writing essays totaling for all three essay questions at least 900 words;
c) grading said essay answers for effective, organized writing, grammar and spelling, and grading said essays for critical thinking, problem solving and task management skills to generate test results and recommendations; and
d) generating and disseminating reports of said test results and recommendations.

2. The web-based computer implemented system for assessment of core educational proficiencies (ACEP) according to claim 1, wherein said assessment testing system comprising a first test and a second test includes administering said second test in at least one year in time after administering said first test to the test taking user.

3. The web-based computer implemented system for assessment of core educational proficiencies (ACEP) according to claim 1, wherein said grading said essay answers for effective, organized writing, grammar and spelling and grading said essays for critical thinking, problem solving and task management skills is performed by both human graders and proprietary grading software.

4. The web-based computer implemented system for assessment of core educational proficiencies (ACEP) according to claim 3, wherein said grading by human graders is performed by two or more human graders which create rubrics and evaluate the effectiveness of the machine grading done by said proprietary grading software.

5. The web-based computer implemented system for assessment of core educational proficiencies (ACEP) according to claim 1, wherein said assessment testing system employs a single rubric that references all skill sets whereby each category within each skill set includes its own rubric and thereby the rubrics are tightly tied to the contexts in which they operate.

6. The web-based computer implemented system for assessment of core educational proficiencies (ACEP) according to claim 1, wherein said essay question test materials are derived from authentic real world published articles relating to actual current events and current affairs of interest to, and affecting the life of students.

7. The web-based computer implemented system for assessment of core educational proficiencies (ACEP) according to claim 2, wherein said assessment testing system effectively tests for learning over at least one year in time and effectively tests a test taking user's critical thinking and problem solving based on comprehension, application, analysis, synthesis and evaluation, a test taking user's soft task management skills, and a test taking user's writing skills.

8. The web-based computer implemented system for assessment of core educational proficiencies (ACEP) according to claim 1, wherein said assessment testing system effectively provides recommendations for improvement for both faculty test users and for student test taking users.

9. The web-based computer implemented system for assessment of core educational proficiencies (ACEP) according to claim 1, wherein said assessment testing system further provides a test taking user with a certificate of completion that ma be evaluated by education institutions employers.

10. The web-based computer implemented system for assessment of core educational proficiencies (ACEP) according to claim 1, wherein said assessment testing system further provides for a bonus system to award bonuses to departments where improvements are measured between said first test and said second test, by test taking users associated with those departments.

11. The web-based computer implemented system for assessment of core educational proficiencies (ACEP) according to claim 1, wherein said assessment test system employs Bloom's taxonomy categories, for critical thinking and problem solving, including comprehension, application, analysis, synthesis and evaluation, thereby providing a clear, acceptable framing for assessing critical thinking.

12. The web-based computer implemented system for assessment of core educational proficiencies (ACEP) according to claim 1, wherein said assessment test system includes an option to complete two separate essay tests at two different times during a one-week tune period, for each of said first test and said second test.

13. A method for making a web-based computer implemented system for assessment of core educational proficiencies (ACEP), comprising the steps of:
a) providing a computer network including one or more dedicated servers, wherein said servers having data storage, memory and display devices configured to develop, control, deploy, operate and administer an assessment testing system and process;
b) said assessment testing system comprising a first test and a second test wherein said first test and said second test each include three essay questions to be answered by writing essays totaling for all three essay questions at least 900 words;
c) grading said essay answers for effective, organized writing, grammar and spelling, and grading said essays for critical thinking, problem solving and task management skills to generate test results and recommendations; and
d) generating and disseminating reports of said test results and recommendations.

14. The method of making a web-based computer implemented system for assessment of core educational proficiencies (ACEP) according to claim 13, wherein said assessment testing system comprising a first test and a second test includes administering said second test in at least one year in time after administering said first test to the test taking user.

15. The method of making a web-based computer implemented system for assessment of core educational proficiencies (ACEP) according to claim 13, wherein said grading said essay answers for effective, organized writing, grammar and spelling and grading said essays for critical thinking, problem solving and task management skills is performed by both human graders and proprietary grading software.

16. The method of making a web-based computer implemented system for assessment of core educational proficiencies (ACEP) according to claim 15, wherein said grading by human graders is performed by two or more human graders which create rubrics and evaluate the effectiveness of the machine grading done by said proprietary grading software.

17. The method of making a web-based computer implemented system for assessment of core educational proficiencies (ACEP) according to claim 13, wherein the assessment test system employs a single rubric that references all skill sets whereby each category within each skill set includes its own rubric and thereby the rubrics are tightly tied to the contexts in which the operate.

18. The method of making a web-based computer implemented system for assessment of core educational proficiencies (ACEP) according to claim 13, wherein said essay question test materials are derived from authentic real world published articles relating to actual current events and current affairs of interest to, and affecting the life of students.

19. The method of making a web-based computer implemented system for assessment of core educational proficiencies (ACEP) according to claim 14, wherein said assessment testing system effectively tests for learning over at least one year in time, and effectively tests a test taking user's critical thinking and problem solving based on comprehension, application, analysis, synthesis and evaluation, a test taking user's soft task management skills, and a test taking user's writing skills.

20. The method of making a web-based computer implemented system for assessment of core educational proficiencies (ACEP) according to claim 13, wherein said assessment testing system effectively provides recommendations for improvement for student test taking users.

21. The method of making a web-based computer implemented system for assessment of core educational proficiencies (ACEP) according to claim 13, wherein said assessment testing system further provides a test taking user with a certificate of completion that may be evaluated by education institutions and employers.

22. The method of making a web-based computer implemented system for assessment of core educational proficiencies (ACEP) according to claim 13, wherein said assessment testing system further provides for a bonus system to award bonuses to departments where improvements are measured between said first test and said second test, by test taking users associated with those departments.

23. The method of making a web-based computer implemented system for assessment of core educational proficiencies (ACEP) according to claim 13, wherein the test system employs Bloom's taxonomy categories, for critical thinking and problem solving, including comprehension, application, analysis, synthesis and evaluation, thereby providing a clear, acceptable framing for assessing critical thinking.

24. The method of making a web-based computer implemented system for assessment of core educational proficiencies (ACEP) according to claim 13, wherein said assessment test system includes an option for the test taking user to complete two separate essay tests at two different times during a one-week time period, for each of said first test and said second test.
